(19) United States
(12) Patent Application Publication
(10) Pub. No.: US 2024/0330018 A1
(43) Pub. Date: Oct. 3, 2024

(54) DECOMPOSITION OF TWO-QUBIT GATES

(71) Applicant: Alibaba Damo (Hangzhou) Technology Co., Ltd., Hangzhou (CN)

(72) Inventors: Dawei DING, San Diego, CA (US); Jiachen HUANG, San Mateo, CA (US); Jianxin CHEN, Kirkland, WA (US)

(21) Appl. No.: 18/613,924

(22) Filed: Mar. 22, 2024

Related U.S. Application Data
(60) Provisional application No. 63/493,299, filed on Mar. 30, 2023.

(51) Int. Cl. G06F 9/448; G06N 10/40

(52) U.S. Cl. CPC G06F 9/448; G06N 10/40

(57) ABSTRACT

A gate sequence can be generated for performing a quantum computation by replacing certain two-qubit gates with AshN gates. The gate sequence can be generated by a classical computing system. Generation of the gate sequence can include identifying, in the gate sequence, a two-qubit gate to be applied to two qubits of a quantum computing system. The two-qubit gate can be associated with Weyl coordinates x, y, and z. An AshN gate can be generated that is locally equivalent to the two-qubit gate using characteristics of the two qubits and the Weyl coordinates. The AshN gate can be included in the gate sequence in place of the identified two-qubit gate. The gate sequence can be applied to the quantum computing system to perform the quantum computation.

### CROSS-REFERENCE TO RELATED APPLICATIONS

This application claims the benefit of U.S. Provisional Application No. 63/493,299, filed Mar. 30, 2023, which is incorporated herein by reference in its entirety.

### TECHNICAL FIELD

The present disclosure generally relates to quantum computing, and more particularly, to decomposition of arbitrary two-qubit gates into other gates.

### BACKGROUND

Quantum computing can address classically intractable computational problems. However, existing quantum computational devices are limited by various sources of error and imprecision. In particular, two-qubit gate operations constitute a major source of complex errors in existing quantum computational devices. Realization of an improved two-qubit gate may improve the performance of quantum computing algorithms and advance the goal of fault-tolerant quantum computation for complex quantum-computational tasks.

### SUMMARY

The disclosed systems and methods relate to implementation of two-qubit gates in a quantum calculation using an AshN dynamic decoupling drive gate (or SWAP gate) and single-qubit gates (if necessary).

The disclosed embodiments include a method for performing a quantum computation. The method can include generating a gate sequence implementing a quantum computational task. The gate sequence can be generated by a classical computing system. Generation of the gate sequence can include identifying, in the gate sequence, a two-qubit gate to be applied to two qubits of a quantum computing system. The two-qubit gate can be associated with Weyl coordinates x, y, and z. Generation of the gate sequence can include determining a dynamic decoupling drive gate locally equivalent to the two-qubit gate. Determination of the dynamic decoupling drive gate can include determining a gate time for the dynamic decoupling drive gate and determining a first amplitude of a first dynamic decoupling drive associated with a first one of the two qubits. The first amplitude of a first dynamic decoupling drive can be determined using the gate time; a sum of the y and z coordinates; and a difference of the y and z coordinates. Generation of the gate sequence can include including the dynamic decoupling drive gate in the gate sequence at least partially in place of the two-qubit gate. The method can include providing commands applying the gate sequence to the quantum computing system and obtaining an output from the quantum computing system.

The disclosed embodiments further include a system configured to perform the above method and computer-readable media containing instructions for configuring a system to perform the above method.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which comprise a part of this specification, illustrate several embodiments and, together with the description, serve to explain the principles and features of the disclosed embodiments. In the drawings:

FIG. 1 depicts the Weyl chamber and the positions of common gates.

FIG. 2A depicts the generation of a variety of locally inequivalent two-qubit gates using a dynamic decoupling drive gate, consistent with disclosed embodiments.

FIG. 2B depicts generation of two-qubit gates in the Weyl chamber between iSWAP and CZ using an AshN gate, consistent with disclosed embodiments.

FIG. 2C depicts the second interaction component of as a function of dynamic drive amplitude, consistent with disclosed embodiments.

FIG. 2D demonstrates that an AshN gate with a single decoupling drive can be used to obtain, up to local equivalence, any two-qubit gate lying on the xy plane of the Weyl chamber, consistent with disclosed embodiments.

FIG. 3 depicts a system for decomposing and applying sequences of quantum gates to implement a quantum computation, in accordance with disclosed embodiments.

FIG. 4 depicts an exemplary method for performing a quantum computational task using AshN gates and single-qubit gates, in accordance with disclosed embodiments.

### DETAILED DESCRIPTION

Reference will now be made in detail to exemplary embodiments, discussed with regards to the accompanying drawings. In some instances, the same reference numbers will be used throughout the drawings and the following description to refer to the same or like parts. Unless otherwise defined, technical or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. Thus, the materials, methods, and examples are illustrative only and are not intended to be necessarily limiting.

Quantum algorithms can be expressed in terms sequences of one or more quantum gates. An arbitrary quantum gate can be implemented using a sequence of other quantum gates. The particular quantum gates used to implement the arbitrary quantum gate can depend on the physical implementation of the quantum device (e.g., a particular physical implementation can be associated with one or more “native” quantum gates). The performance of the arbitrary quantum gate can depend on the performance of the native quantum gates used to implement the arbitrary quantum gate.

As described above, two-qubit gate operations constitute a major source of complex errors in existing quantum computational devices. The disclosed embodiments concern implementation of arbitrary two-quantum gates using a type of decoupling drive gate, the AshN gate, in combination with other single-qubit quantum gates.

As disclosed herein, general quantum circuits can be implemented using AshN gates (and any necessary single-qubit gates). In some embodiments, an arbitrary two-qubit gate (excepting a SWAP gates) can be implemented into an AshN gate. The parameters of the AshN gate can be determined on a classical computational device, and the compiled sequence can be readily run on an arbitrary quantum computational device supporting a native implementation of the AshN gate. In some embodiments, an AshN gate can be implemented using two transversally coupled qubits in resonance while each qubit is also under the influence of a microwave drive. As may be appreciated, other implementations are also possible. As an example, two transmon qubits can be capacitively coupled, each with its own microwave drive. In some embodiments, the microwave drives can be sinusoidal with fixed frequency and amplitude. As an additional example, an AshN gate can also be implemented using a flux drive configured to obtain a similar Hamiltonian.

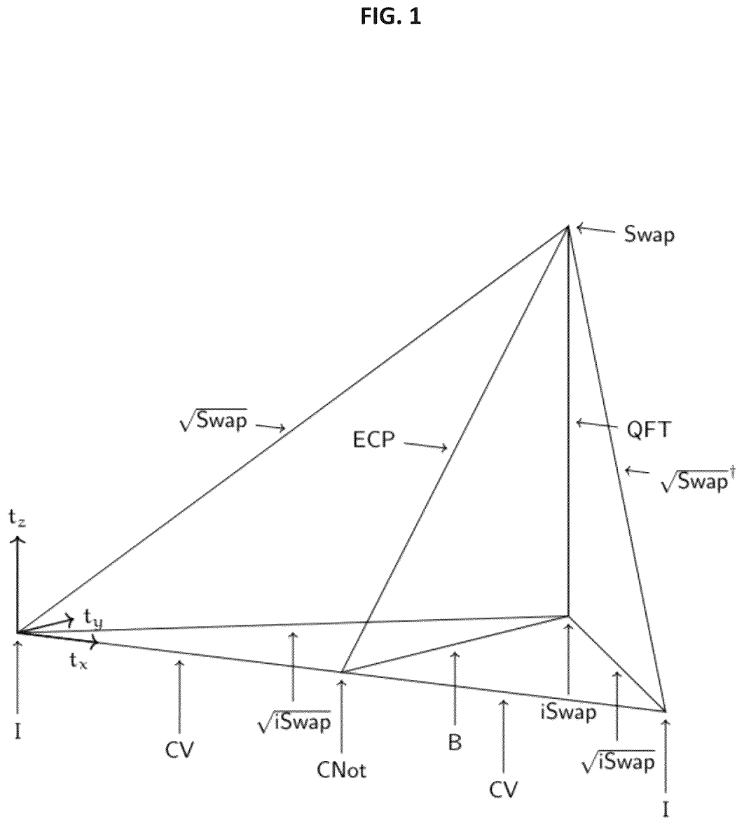

A general two-qubit gate can be mathematically formulated as an element of the special unitary group SU(4). The KAK decomposition and Weyl chamber provide mathematical tools to characterize two-qubit gates up to single qubit gates. FIG. 1 depicts the Weyl chamber and the positions of common gates (e.g., the B gate, CNOT gate, CZ gate, SWAP gate, iSWAP gate, identity gate, \sqrt{SWAP} gate, \sqrt{iSWAP} gate, QFT gate, and ECP gate). Theorem 1 (KAK decomposition). For an arbitrary U∈SU(4), there exists a unique

$$\vec{η} = ( x , y , z ) , \frac{π}{4} \geq x \geq y \geq \vert z \vert ,$$

single qubit rotations A₀, A₁, B₀, B₁ ∈ SU(2) and a global phase g ∈ {1, i} such that U=g·(A₁⊗A₂) exp {i\vec{η}·\vec{Σ}}(B₁⊗B₂), where \vec{Σ}= [σ_{X}⊗σ_{X}, σ_{Y}⊗σ_{Y}, σ_{Z}⊗σ_{Z}]. The tuple (g, \vec{η}, A₀, A₁, B₀, B₁) is called the KAK decomposition of the unitary U. The equivalence class of a unitary U under local unitaries, denoted as Ū, is characterized by the interaction coefficients η(U), which lives in a 3-dimensional tetrahedron called the Weyl chamber:

$$W ≡ \{ \frac{π}{4} \geq x \geq y \geq \vert z \vert \vert ( x , y , z ) ∈ {ℝ}^{3} \} .$$

Two unitaries U, V ∈ SU(4) are locally equivalent, or U˜V, if η(U)=η(V). Let L(x, y, z)≡exp (i[x, y, z]·\vec{Σ}) be the canonical element of the equivalence class. Then U˜L (η(U)) for all U ∈ SU(4).

Consistent with disclosed embodiments, adjusting the parameters of a dynamic decoupling drive gate can result in different two-bit gates. Given two qubits, at resonance and with one dynamic decoupling drive on the second qubit, the Hamiltonian can be formulated as:

$$H ( Ω ) = g ( X ⊗ X + Y ⊗ Y ) + Ω I ⊗ X$$

In this example, g is the transverse coupling strength between the qubits and Ω is the drive amplitude. The matrix exponential of the Hamiltonian can be taken as:

$$exp [ - it / 2 ⋆ H ( Ω ) ] = [ \begin{matrix}A ( g , t , Ω ) & B ( g , t , Ω ) & C ( g , t , Ω ) & D ( g , t , Ω ) \\ B ( g , t , Ω ) & A ( g , t , Ω ) & D ( g , t , Ω ) & C ( g , t , Ω ) \\ C ( g , t , Ω ) & D ( g , t , Ω ) & A ( g , t , Ω ) & B ( g , t , Ω ) \\ D ( g , t , Ω ) & C ( g , t , Ω ) & B ( g , t , Ω ) & A ( g , t , Ω )\end{matrix} ] \\$$

$$where : \\ A ( g , t , Ω ) = Cos [ \frac{gt}{2} ] Cos [ \frac{1}{2} t \sqrt{{g}^{2} + {Ω}^{2}} ] + \frac{g Sin [ \frac{gt}{2} ] Sin [ \frac{1}{2} t \sqrt{{g}^{2} + {Ω}^{2}} ]}{\sqrt{{g}^{2} + {Ω}^{2}}} \\ B ( g , t , Ω ) = \frac{i Ω Cos [ \frac{gt}{2} ] Sin [ \frac{1}{2} t \sqrt{{g}^{2} + {Ω}^{2}} ]}{\sqrt{{g}^{2} + {Ω}^{2}}} \\ C ( g , t , Ω ) = \frac{Ω Sin [ \frac{gt}{2} ] Sin [ \frac{1}{2} t \sqrt{{g}^{2} + {Ω}^{2}} ]}{\sqrt{{g}^{2} + {Ω}^{2}}} \\ D ( g , t , Ω ) = - i ( Cos [ \frac{1}{2} t \sqrt{{g}^{2} + {Ω}^{2}} ] Sin [ \frac{gt}{2} ] + \frac{g Cos [ \frac{gt}{2} ] Sin [ \frac{1}{2} t \sqrt{{g}^{2} + {Ω}^{2}} ]}{\sqrt{{g}^{2} + {Ω}^{2}}} )$$

In this example, the parameters g, t, and Ω can be chosen to achieve the dynamic drive CZ gate (equivalent to the MS gate):

$$DDCZ = \frac{1}{\sqrt{2}} [ \begin{matrix}1 & 0 & 0 & - i \\ 0 & 1 & - i & 0 \\ 0 & - i & 1 & 0 \\ - i & 0 & 0 & 1\end{matrix} ]$$

For example, selecting:

$$sin ( \frac{1}{2} t \sqrt{{g}^{2} + {Ω}^{2}} ) = 0$$

causes B (g, t, Ω)=C (g, t, Ω)=0. Thus:

$$\frac{1}{2} t \sqrt{{g}^{2} + {Ω}^{2}} = k π$$

$$so$$

$$Ω = \sqrt{\frac{4 {k}^{2} {π}^{2}}{{t}^{2}} - {g}^{2}}$$

which in turn implies

$$cos ( \frac{1}{2} t \sqrt{{g}^{2} + {Ω}^{2}} ) = \pm 1$$

The appropriate coefficients can be obtained as follows:

$$sin ( \frac{gt}{2} ) ,$$

$$cos ( \frac{gt}{2} ) = \pm \frac{1}{\sqrt{2}}$$

and then

$$\frac{gt}{2} = π / 4 + j π / 2$$

$$so$$

$$t = π / 2 g + j π / g$$

so to obtain the smallest positive solutions for the drive amplitude Ω and the time t, j=0, and

$$t = π / 2 g$$

$$Ω = \sqrt{\frac{4 {k}^{2} {π}^{2}}{{( π / 2 g )}^{2}} - {g}^{2}} = \sqrt{16 {k}^{2} - 1} * g$$

$$then$$

$$exp [ - i π / 4 g * H ( \sqrt{15} g ) ] = \frac{1}{\sqrt{2}} [ \begin{matrix}- 1 & 0 & 0 & i \\ 0 & - 1 & i & 0 \\ 0 & i & - 1 & 0 \\ i & 0 & 0 & - 1\end{matrix} ]$$

which is the DDCZ gate up to a global phase.

A more complicated Hamiltonian can be used, which includes a ZZ error. In some such embodiments, a dynamic decoupling drive can be applied to each qubit:

$$H ( {Ω}_{1} , {Ω}_{2} ) = g ( X ⊗ X + Y ⊗ Y ) + {Ω}_{1} X ⊗ I + {Ω}_{2} I ⊗ X + hZ ⊗ Z$$

The matrix exponentiation of this Hamiltonian (exp [−it/2*H (Ω₁, Ω₂)]) can be obtained.

The (00,01) entry of this matrix exponential can be set to zero when Ω₁ and Ω₂ satisfy the relation:

$$\frac{1}{2} it \times 2 \sqrt{{( g - h )}^{2} + {( {Ω}_{1} + {Ω}_{2} )}^{2}} = 2 ik π$$

$$\frac{1}{2} it \times 2 \sqrt{{( g + h )}^{2} + {( {Ω}_{1} - {Ω}_{2} )}^{2}} = 2 ij π$$

Then setting t=π/2g the appropriate amplitudes can be obtained as:

$${Ω}_{1} = \frac{\sqrt{16 {k}^{2} {g}^{2} - {( g - h )}^{2}} + \sqrt{16 {j}^{2} {g}^{2} - {( g + h )}^{2}}}{2}$$

$${Ω}_{2} = \frac{\sqrt{16 {k}^{2} {g}^{2} - {( g - h )}^{2}} + \sqrt{16 {j}^{2} {g}^{2} - {( g + h )}^{2}}}{2}$$

The values of k and j can be selected (e.g., in this case as k=j=1):

$${Ω}_{1} = \frac{\sqrt{16 {g}^{2} - {( g - h )}^{2}} + \sqrt{16 {g}^{2} - {( g + h )}^{2}}}{2}$$

$${Ω}_{2} = \frac{\sqrt{16 {g}^{2} - {( g - h )}^{2}} - \sqrt{16 {g}^{2} - {( g + h )}^{2}}}{2}$$

These equations place boundaries on the values of g and h. When |g−h|, |g+h|≤4g, or h ∈ [−3g, 3g], there exists a real solution. For such values of g and h, the exponentiated Hamiltonian is the DDCZ gate up to a global phase.

In some embodiments, a DDCZ can incur the same kind of single qubit phase errors as an fSim gate. Such errors may be expressed in a rotating frame of reference as:

$$( \text{?} ⊗ {Z}_{δ} ) DDCZ ( {Z}_{α} ⊗ {Z}_{β} )$$

$$\text{?} \text{indicates text missing or illegible when filed}$$

These errors can be dealt with by absorbing them into the adjoining single-qubit gates or by using customized compilation schemes for specific circuits like syndrome extraction.

Adding a phase shift to the single DD pulse in the simplified model for DDCZ implements the following Hamiltonian:

$$g ( X ⊗ X + Y ⊗ Y ) + Ω ( cos ϕ \vert \cdot I ⊗ X + sin ϕ \cdot I ⊗ Y )$$

The corresponding unitary can be expressed as:

$$exp [ - it / 2 ( g ( X ⊗ X + Y ⊗ Y ) + Ω ( cos ϕ \cdot I ⊗ X + sin ϕ \cdot I ⊗ Y ) ] = exp [ - it / 2 ( {Z}_{- ϕ} ⊗ {Z}_{- ϕ} ) ( g ( X ⊗ X + Y ⊗ Y ) + Ω I ⊗ X ) ( {Z}_{ϕ} ⊗ {Z}_{ϕ} ) ] = ( {Z}_{- ϕ} ⊗ {Z}_{- ϕ} ) exp [ - it / 2 ( g ( X ⊗ X + Y ⊗ Y ) \vert + Ω I ⊗ X ) ] ( {Z}_{ϕ} ⊗ {Z}_{ϕ} )$$

using the excitation number conserving property of iSWAP family gates:

$$X ⊗ X + Y ⊗ Y = [ \begin{matrix}0 & 0 & 0 & 1 \\ 0 & 0 & 1 & 0 \\ 0 & 1 & 0 & 0 \\ 1 & 0 & 0 & 0\end{matrix} ] + [ \begin{matrix}0 & 0 & 0 & - 1 \\ 0 & 0 & 1 & 0 \\ 0 & 1 & 0 & 0 \\ - 1 & 0 & 0 & 0\end{matrix} ] = [ \begin{matrix}0 & 0 & 0 & 0 \\ 0 & 0 & 2 & 0 \\ 0 & 2 & 0 & 0 \\ 0 & 0 & 0 & 0\end{matrix} ]$$

and therefore:

$$( {Z}_{- ϕ} ⊗ {Z}_{- ϕ} ) ( X ⊗ X + Y ⊗ Y ) ( {Z}_{ϕ} ⊗ {Z}_{ϕ} ) = ( X ⊗ X + Y ⊗ Y ) ( {Z}_{- ϕ} ⊗ {Z}_{- ϕ} ) ( {Z}_{ϕ} ⊗ {Z}_{ϕ} ) = ( X ⊗ X + Y ⊗ Y )$$

Therefore, when t=π/2g and Ω=\sqrt{15g}, the implemented unitary can be:

$$( {Z}_{- ϕ} ⊗ {Z}_{- ϕ} ) DDCZ ( {Z}_{ϕ} ⊗ {Z}_{ϕ} )$$

As a further step in this derivation, a phase shift can be added to each dynamic decoupling drive pulse in the case in which there are ZZ errors. The Hamiltonian then becomes:

$$g ( X ⊗ X + Y ⊗ Y ) + {Ω}_{1} ( cos {ϕ}_{1} \cdot X ⊗ I + sin {ϕ}_{1} \cdot Y ⊗ I ) + {Ω}_{2} ( cos {ϕ}_{2} \cdot I ⊗ X + sin {ϕ}_{2} I ⊗ Y ) + hZ ⊗ Z$$

When the phase shifts of the dynamic decoupling drive are equal, the effect can be the same as in the single dynamic decoupling drive pulse case.

For ϕ1≠ϕ2, setting t=π/2g and using the amplitude relationships given above, the unitary obtained is in general not locally equivalent to the DDCZ gate. Values of t, Ω₁, and Ω₂ for obtaining the DDCZ gate may be dependent on ϕ₁, and ϕ₂.

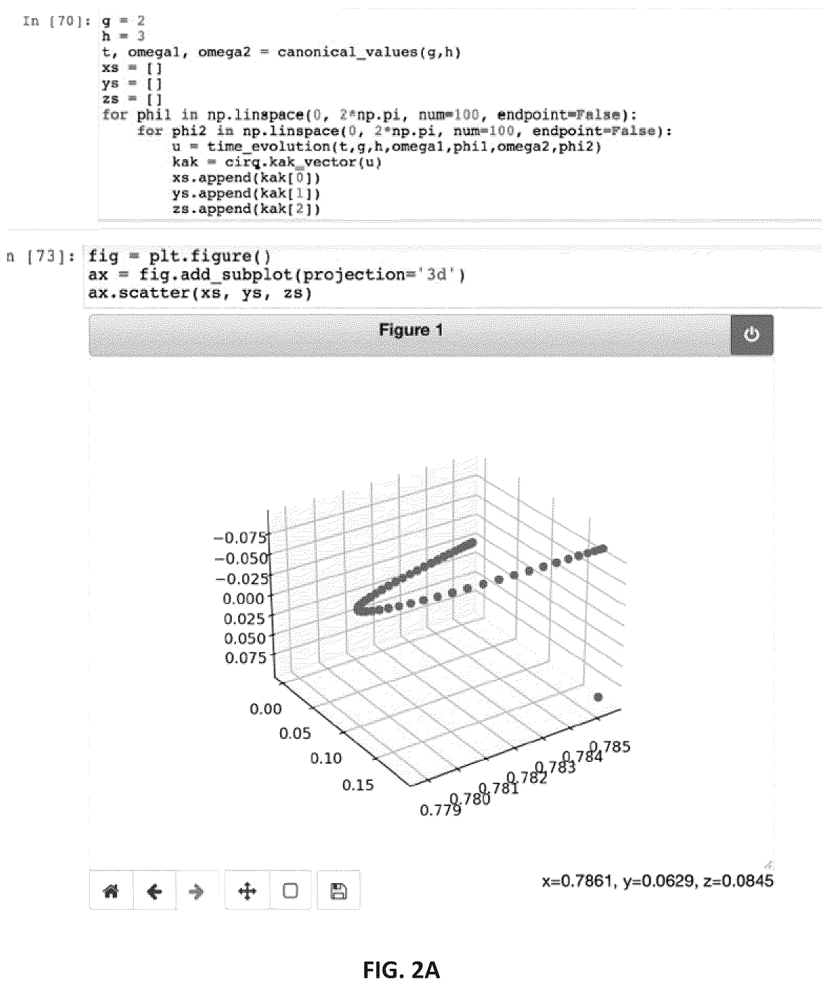

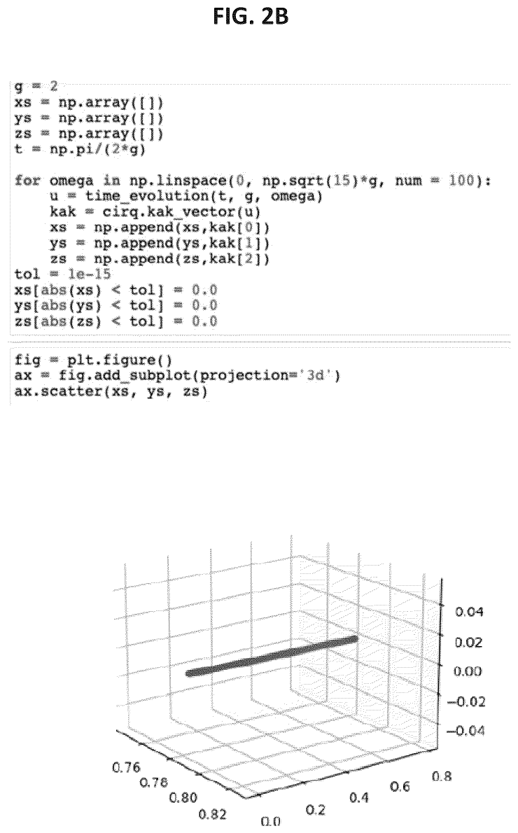

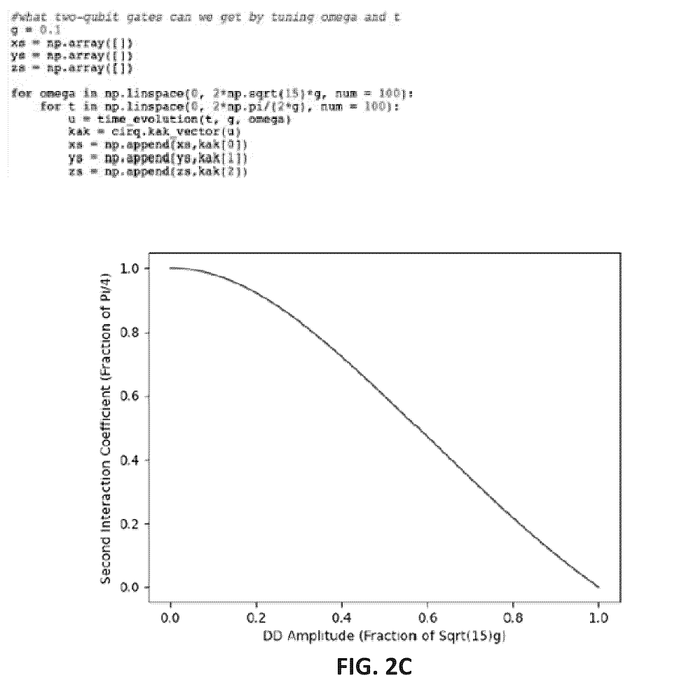

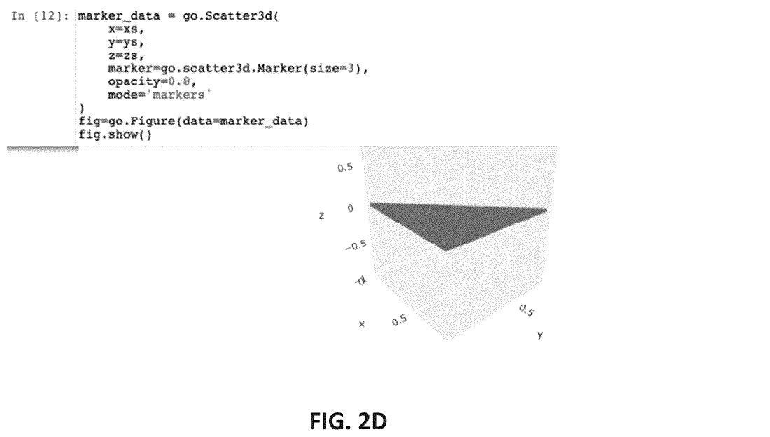

Depending on values of g and h, different locally inequivalent gates can be obtained. FIG. 2A depicts the generation of such a variety of locally inequivalent two-qubit gates using a dynamic decoupling drive gate, consistent with disclosed embodiments. The axes of the depicted chart are the Cartan decomposition parameters for the gate having the specified values of g and h.

Consistent with disclosed embodiments, the AshN gate can be defined as

$$AshN ( t , Ω ) := exp [ - iH ( Ω ) t / 2 ]$$

$$where$$

$$H ( Ω ) = g ( X ⊗ X + Y ⊗ Y ) + Ω I ⊗ X$$

As shown above, the iSWAP and DDCZ gates can be realized using certain gate drive (Ω) and time value (t) s:

$$AshN ( π / 2 g , 0 ) = iSWAP$$

$$AshN ( π / 2 , g \sqrt{15} g ) = DDCZ$$

By varying the gate drive (Ω) on the interval [0, \sqrt{15}g], two-qubit gates in the Weyl chamber between the iSWAP and DDCZ gates can be realized. FIG. 2B depicts generation of such two-qubit gates in the Weyl chamber between iSWAP and CZ using an AshN gate, consistent with disclosed embodiments. The axes of the depicted chart are the Cartan decomposition parameters for the gate having the specified values of Ω and t, as Ω varies on the interval [0, \sqrt{15}g].

In particular, as depicted in FIG. 2B, there exists a gate drive Ω_{B} in the interval [0, \sqrt{15}g] such that the Cartan decomposition parameters of a gate having the parameters AshN (π/2g,Ω_B)=(π/4,π/8,0). Thus there exists a gate drive capable of realizing the B gate.

FIG. 2C depicts the second interaction component of as a function of dynamic drive amplitude, consistent with disclosed embodiments. The second interaction component has been normalized to π/4, while the dynamic drive amplitude has been normalized to \sqrt{15}g.

FIG. 2D depicts the Cartan decomposition parameters for a gate AshN (t, Ω) having the parameter t vary between 0 and π/g and the parameter Ω vary between 0 and 2\sqrt{15}g. As shown, the AshN gate with a single decoupling drive can be used to obtain, up to local equivalence, any two-qubit gate lying on the xy plane of the Weyl chamber, consistent with disclosed embodiments.

Consistent with disclosed embodiments, suitable values of the parameters t and Ω can be calculated directly. The Makhlin invariants can be calculated as:

$${G}_{1} := \frac{{tr}^{2} [ m ( U ) ]}{16 det U}$$

$${G}_{2} := \frac{{tr}^{2} [ m ( U ) ] - tr [ {m}^{2} ( U ) ]}{4 det U}$$

$$where$$

$$m ( U ) := {( {Q}^{†} UQ )}^{T} {Q}^{†} UQ$$

$$Q := \frac{1}{\sqrt{2}} [ \begin{matrix}1 & 0 & 0 & i \\ 0 & i & 1 & 0 \\ 0 & i & - 1 & 0 \\ 1 & 0 & 0 & - i\end{matrix} ] .$$

The matrix exponential for the gate AshN (t, Ω) can be plugged into the formula for the Makhlin invariants to obtain:

$${G}_{1} = {cos}^{2} ( gt ) \frac{{Ω}^{2} + {g}^{2} {cos ( t \sqrt{{g}^{2} + {Ω}^{2}} )}^{2}}{{( {g}^{2} + {Ω}^{2} )}^{2}}$$

$${G}_{2} = 2 {cos}^{2} ( gt ) + \frac{{2 [ {Ω}^{2} + {g}^{2} cos ( t \sqrt{{g}^{2} + {Ω}^{2}} ) ]}^{2}}{{( {g}^{2} + {Ω}^{2} )}^{2}} - 1$$

G₁ is real for all g, t, Ω and therefore one of the Cartan interaction coefficients is zero. By projecting to the Weyl chamber defined by:

$$\frac{π}{4} \geq x \geq y \geq \vert z \vert$$

it can be seen that z=0 for all g, t, Ω.

The Makhlin invariants can be related to the Cartan interaction coefficients as follows:

$${G}_{1} = {cos}^{2} ( 2 x ) {cos}^{2} ( 2 y ) {cos}^{2} ( 2 z ) - {sin}^{2} ( 2 x ) {sin}^{2} ( 2 y ) {sin}^{2} ( 2 z ) + \frac{i}{4} sin ( 4 x ) sin ( 4 y ) sin ( 4 z )$$

$${G}_{2} = 4 {cos}^{2} ( 2 x ) {cos}^{2} ( 2 y ) {cos}^{2} ( 2 z ) - 4 {sin}^{2} ( 2 x ) {sin}^{2} ( 2 y ) {sin}^{2} ( 2 z ) - cos ( 4 x ) cos ( 4 y ) cos ( 4 z )$$

By setting z=0, these relationships can be simplified to:

$${G}_{1} = {cos}^{2} ( 2 x ) {cos}^{2} ( 2 y )$$

$${G}_{2} = 2 {cos}^{2} ( 2 x ) + 2 {cos}^{2} ( 2 y ) - 1$$

These equations can be mapped to the Makhlin invariants formula when:

$${cos}^{2} ( 2 x ) = {cos}^{2} ( gt )$$

$${cos}^{2} ( 2 y ) = \frac{{[ {Ω}^{2} + {g}^{2} cos ( t \sqrt{{g}^{2} + {Ω}^{2}} ) ]}^{2}}{{( {g}^{2} + {Ω}^{2} )}^{2}}$$

As described above, x,

$$y ∈ [ 0 , \frac{π}{4} ] .$$

Therefore cos (2x), cos (2y)≥0. Because these functions are positive:

$$cos ( 2 x ) = cos ( gt )$$

$$cos ( 2 y ) = \frac{{Ω}^{2} + {g}^{2} cos ( t \sqrt{{g}^{2} + {Ω}^{2}} )}{{g}^{2} + {Ω}^{2}}$$

and therefore x=½gt and

$$y = \frac{1}{2} {cos}^{- 1} [ \frac{{Ω}^{2} + {g}^{2} cos ( t \sqrt{{g}^{2} + {Ω}^{2}} )}{{g}^{2} + {Ω}^{2}} ]$$

These relationships can be used to generate the entire xy plane of the Weyl chamber. For example, take t ∈ [0, π/2g] to obtain all x ∈ [0, π/4]. When t=0 then taking Ω=0 obtains the point (0,0). For fixed t>0, take Ω=0 to obtain y=x. Then take

$$Ω = \sqrt{\frac{4 {π}^{2}}{{t}^{2}} - {g}^{2}}$$

to obtain y=0. Since y is a continuous function of Ω, all values of y∈[0, x] can be obtained by varying Ω. Consistent with disclosed embodiments, the DDCZ gate can be obtained by setting t=π/2g (so that x=π/4). Then:

$${lim}_{Ω \to ∞} y = 0$$

To obtain the B gate, the above relationships can be solved for x=π/4, y=π/8. In a first step, t can be selected to be:

$$t = π / 2 g$$

while the relation:

$$\frac{π}{8} = \frac{1}{2} {cos}^{- 1} [ \frac{{Ω}^{2} + {g}^{2} cos ( \frac{π}{2 g} \sqrt{{g}^{2} + {Ω}^{2}} )}{{g}^{2} + {Ω}^{2}} ]$$

$$implies$$

$$\frac{1}{\sqrt{2}} = \frac{ζ + cos ( \frac{π}{2} \sqrt{1 + ζ} )}{1 + ζ}$$

where

$$ζ = {( \frac{Ω}{g} )}^{2} .$$

This equation can be solved numerically to obtain ζ₀≈5.00712. Thus to obtain the B gate, an AshN gate can be applied with t=π/2g and Ω=\sqrt{ζ₀}g.

As described herein, the Hamiltonian for the two drive dynamically driven two-qubit gate can be:

$$H ( {Ω}_{1} , {Ω}_{2} ) = g ( X ⊗ X + Y ⊗ Y ) + {Ω}_{1} X ⊗ I + {Ω}_{2} I ⊗ X + hZ ⊗ Z$$

Taking advantage of mutually commutative terms, the Hamiltonian can be locally conjugated as X→Z, Y→X, Z→−Y to get

$${H}^{′} ( {Ω}_{1} , {Ω}_{2} ) = ( gZ ⊗ Z + {Ω}_{1} I ⊗ Z + {Ω}_{2} Z ⊗ I ) + gX ⊗ X = [ \begin{matrix}g + {Ω}_{1} + {Ω}_{2} & 0 & 0 & g \\ 0 & - g - {Ω}_{1} + {Ω}_{2} & g & 0 \\ 0 & g & - g + {Ω}_{1} - {Ω}_{2} & 0 \\ g & 0 & 0 & g - {Ω}_{1} - {Ω}_{2}\end{matrix} ]$$

The modified Hamiltonian H′ has invariant subspaces {|00 [symbol] , |11 [symbol] }, {|10 [symbol] , |01 [symbol] } and the corresponding unitary U(t, Ω₁, Ω₂):=exp{−itH′ (Ω₁, Ω₂)} has the same spaces and non-zero entries. In some embodiments, U(t, Ω₁, Ω₂)=e^{-igt}V₀+e^{igt}V₁, where V₀ and V₁ are two SU(2) rotations acting on subspaces spanned by {|00 [symbol] , |11 [symbol] } and {|10 [symbol] , |01 [symbol] }, respectively. As the two subspaces are also invariant under R_{Z}(α)⊗R_{Z}(β), it follows that:

$$( {R}_{Z} ( α ) ⊗ {R}_{Z} ( β ) ) U ( t , {Ω}_{1} , {Ω}_{2} ) ( {R}_{Z} ( γ ) ⊗ {R}_{Z} ( δ ) ) = {{e}^{- igt} ( {R}_{Z} ( α + β ) {V}_{0} {R}_{Z} ( γ + δ ) )}_{00 , 11} + {{e}^{igt} ( {R}_{Z} ( α - β ) {V}_{1} {R}_{Z} ( γ - δ ) )}_{01 , 10} .$$

Therefore, in terms of local equivalence, the gate can be determined by the relative phase differences between the two blocks gt, and

$$\vert 〈 0 \vert {V}_{0} \vert 1 〉 \vert = sin ( t * \sqrt{{( {Ω}_{1} + {Ω}_{2} )}^{2} + {g}^{2}} ) * \frac{\text{?}}{\sqrt{{( {Ω}_{1} + {Ω}_{2} )}^{2} + {g}^{2}}} \text{?}$$

$$\vert 〈 0 \vert {V}_{1} \vert 1 〉 \vert = sin ( t * \sqrt{{( {Ω}_{1} - {Ω}_{2} )}^{2} + {g}^{2}} ) * \frac{g}{\sqrt{{( {Ω}_{1} + {Ω}_{2} )}^{2} + {g}^{2}}}$$

$$\text{?} \text{indicates text missing or illegible when filed}$$

In the context of the canonical Weyl chamber elements:

$$exp \{ i ( aXX + bYY + cZZ ) \} = exp \{ i * [ \begin{matrix}c & 0 & 0 & a + b \\ 0 & - c & a - b & 0 \\ 0 & a - b & - c & 0 \\ a + b & 0 & 0 & c\end{matrix} ] \}$$

The canonical elements also have invariant subspaces spanned by {|00 [symbol] , |11 [symbol] } and {|10 [symbol] , |01 [symbol] } with the corresponding three characteristics being c, sin (a+b), and sin (a−b). The Weyl chamber can be defined as

$$\frac{π}{4} \geq c \geq a \geq \vert b \vert ,$$

where 1≥sin (a+b)≥sin (a−b)≥0. The first equality is satisfied only for the SWAP gate. Otherwise, there exists a U (t, Ω₁, Ω₂) that generates a local equivalent. Let t=(2kπ+c)/g for some k∈ [symbol] . Then given:

$$f ( θ ) = sin ( t θ ) \cdot \frac{g}{θ} , θ ∈ \vert g , ∞ )$$

we have |f(θ)|≤1, but any number in the interval (−1,1) can be achieved using the appropriate selection of k. Therefore both sin (a+b) and sin (a−b), can be achieved using an appropriate selection of k, and θ₁ and θ₂ that result in desired selections of Ω₁ and Ω₂. However, the SWAP gate cannot be achieved using such a construction, as the SWAP gate requires

$$gt = \frac{π}{2} + k π$$

and f(θ)=1, which cannot be simultaneously achieved.

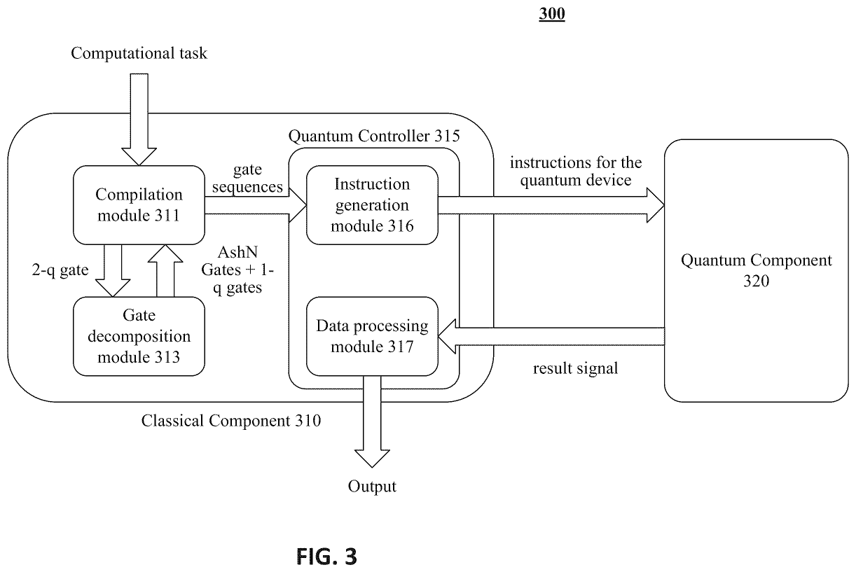

FIG. 3 depicts a system 300 for determining sequences of quantum gates that implement a quantum computation, in accordance with disclosed embodiments. The system 300 can include a classical component 310 (e.g., a classical computing device, or collection of classical computing devices) and a quantum component 320.

The classical component 310 can be configured to control the quantum device 320. The classical component can include a compilation module 311. Compilation module 311 can be configured to obtain a description of a quantum computation task (a unitary, a quantum circuit, etc.) and determine an implementation of the quantum computation task. The implementation can be a gate sequence. The gate sequence can include AshN gates (and SWAP gates, if necessary) and single-qubit gates.

In some embodiments, gate module 313 (which may be implemented as a submodule of compilation module 311) can be configured to determine parameters of an AshN gate locally equivalent to a given two-qubit gate. In some embodiments, gate module 313 can also determine single qubit gates such that composition of the single qubit gates and AshN gate equal the given two-qubit gate, up to a global phase. Gate decomposition module 313 can obtain a two-qubit gate from compilation module 311. In response, gate decomposition module 313 can determine and provide to compilation module 311 parameters of an AshN gate locally equivalent to the given two-qubit gate (and parameters for any single qubit gates necessary to implement the obtained two-qubits gate).

Quantum controller 315 can be configured to directly control quantum component 320. Quantum controller 315 can be a digital computing device (e.g., a computing device including a central processing unit, graphical processing unit, application specific integrated circuit, field-programmable gate array, or other suitable processor). Quantum controller 315 can configure quantum component 320 for computation, provide quantum gates to, and read state information out of quantum circuit 320.

Quantum controller 315 can include an Instruction Generation Module 316. Instruction Generation Module 316 can be configured to directly or indirectly provide bias drives to quantum circuit 320 to enable or disable interactions between qubits. Instruction Generation Module 316 can indirectly provide bias drives by providing instructions to a bias drive source (e.g., waveform generator or the like), causing the bias drive source to provide the bias drives to circuit 320. Instruction Generation Module 316 can apply quantum gates by providing one or more microwave pulses (or other gate drives) to qubits in quantum component 320. In various embodiments, Instruction Generation Module 316 can implement such gates by providing instructions to a computation drive source (e.g., a waveform generator or the like), causing the computational drive source to provide such microwave pulses (or other gate drives) to qubits in quantum component 320. The microwave pulses can be selected or configured to implement one or more quantum gates, as described herein. The microwave pulses can be provided to qubits using one or more coils coupled to the corresponding qubits. The coils can be external to quantum component 320 or on a chip implementing quantum component 320.

Quantum controller 315 can be configured to determine state information for quantum component 320. In some embodiments, quantum controller 315 can measure a state of one or more qubits of quantum component 320. The state can be measured upon completion of a sequence of one or more quantum operations. In some embodiments, instruction Generation Module 316 can provide a probe signal (e.g., a microwave probe tone) to a coupled resonator of quantum component 320, or provide instructions to a readout device (e.g., an arbitrary waveform generator) that provides the probe signal.

In various embodiments, quantum controller 315 can include a data processing module 317. Data processing module 317 can take the output signal (e.g. electrical/photonic), transforms it into discrete signals, and do data processing on it (e.g. averaging, post-processing) to obtain a computational result. In some embodiments, data processing module 317 can include, or be configured to receive information from, a detector configured to determine an amplitude and phase of an output signal received from the coupled resonator in response to provision of the microwave probe tone. The amplitude and phase of the output signal can be used to determine the state of the probed qubit(s). The disclosed embodiment are not limited to any particular method of measuring the state of the qubits.

Quantum component 320 can be configured to receive commands (e.g., bias drives, quantum gates, probe signal, or the like) from the classical component 310. In some embodiments, quantum component 320 can be implemented using a superconducting quantum circuit coupled to quantum controller 315 using at least one microwave drive line. The superconducting quantum circuit can implement multiple qubits (e.g., transmon qubits, fluxonium qubits, or any other suitable type of qubit), consistent with disclosed embodiments. In some embodiments, the superconducting quantum circuit can be realized using one or more chips containing the qubits, each of the chip(s) including at least a portion of the microwave drive line(s) coupling the qubit(s) to quantum controller 315.

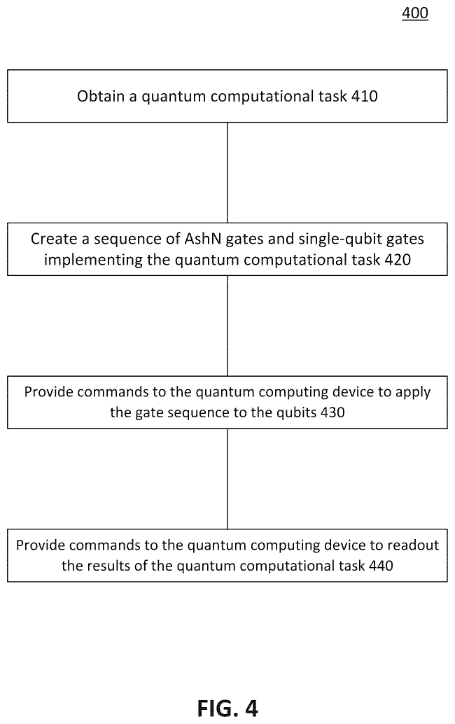

FIG. 4 depicts an exemplary method 400 for performing a quantum computational task using AshN gates and single-qubit gates, in accordance with disclosed embodiments. In some embodiments, method 400 can be performed using system 300. Method 400 can include operations performed on a conventional computing device (e.g., a mobile device, laptop, desktop, workstation, computing cluster, cloud-computing platform, or the like) and operations performed on a quantum computing device (e.g., a quantum controller managing a superconducting circuit, trapped ion quantum systems, topological quantum computing systems, photonic quantum computing systems, or the like). A gate sequence can be generated by the conventional computing device. The conventional computing device can provide instructions configuring the quantum computing device to apply the gate sequences to an appropriate arrangement of qubits. The quantum computing device can perform the quantum computational task by applying the gate sequence. The conventional computing device can then provide instructions to the quantum computing device to read out the results of the quantum computational task.

In step 410, the conventional computing device (e.g., classical component 310) can obtain a description of a quantum computational task. Consistent with disclosed embodiments, the description of the quantum computational task can include a sequence of quantum gates applied to a set of two or more qubits, a unitary matrix acting on the set of two or more qubits, a function call for a quantum algorithm, or another suitable description. The conventional computing device can receive or retrieve the description of the quantum computational task from another system or a user of the conventional computing device. For example, a user can interact with an interface provided by the conventional computing device to generate the description of the quantum computational task.

In step 420, the conventional computing device can create a sequence of AshN gates and single-qubit gates implementing the quantum computational task. If necessary, the sequence can include SWAP gates. In some embodiments, the conventional computing device can create a first implementation of the quantum computational task as a sequence of arbitrary two-qubit gates. Consistent with disclosed embodiments, each two-qubit gate can then be implemented using AshN gates and (and optionally single qubit gates).

For example, when the description of the quantum computational task includes a unitary, the unitary can be decomposed into a sequence of gates. The sequence of gates can include two qubit gates. The disclosed embodiments are not limited to any particular method of decomposing the unitary into a sequence of gates. Similarly, when the description of the quantum computational task includes a function call, the conventional computing device can get a sequence of gates implementing the function call. The disclosed embodiments are not limited to any particular method of generating such a sequence of gates.

Consistent with disclosed embodiments, the conventional computing device can be configured to convert one or more gates in a sequence of gates (e.g., received or retrieve by the conventional computing device, or generated by the conventional computing device) into an AshN gate locally equivalent to the one or more gates. The conventional computing device can further be configured to generate one or more single-qubit gates to apply together with the AshN gate to yield the one or more gates. For example, the conventional computing device can convert the sequence of gates into a corresponding sequence of AshN gates (and additionally SWAP and/or single-qubit gates).

In some embodiments, as part of converting the sequence of gates, the conventional computing device can identify a two-qubit gate. As described herein, in some embodiments a SWAP gate cannot be implemented using an AshN gate. Accordingly, the conventional computing device can be configured to determine whether the two-qubit gate is a SWAP gate. The conventional computing device can determine an AshN implementation of the two-qubit gate in response to a determination that the two-qubit gate is not a SWAP gate. Accordingly, the converted sequence of gates may include both SWAP gates and AshN gates.

The conventional computing device can determine Weyl coordinates x, y, and z for the identified two-qubit gate. For example, the conventional computing device can perform a KAK decomposition to determine the interaction coefficients for the two-qubit gate. The conventional computing device can then determine the values of the drive time and drive amplitudes for each of the qubits. In a first step, the conventional computing device can determine the gate time using an interaction strength of the two qubits and the identified x coordinate of the two-qubit gate. The conventional computing device can determine a gate time such that the product of the interaction strength and the gate time (e.g., gt) is equivalent to the x coordinate. This equivalence can be determined by an equivalency condition. For example, gt can be equivalent to x when f₁(gt)=f₂(x). As an additional example, gt can be equivalent to x when |sin (gt)|=sin(x)).

In some embodiments, the conventional computing device can determine a set of candidate gate times that satisfy the equivalency condition (e.g., given an interaction strength). For example, when the equivalency condition is |sin (gt)|=sin(x)), such candidate gate times can include t₀=x/g, t₁=π/2−x/g, etc.

In some embodiments, the conventional computing device can select from the set of candidate gate times a gate time. In some instances, the selected gate time can be the minimum gate time. In some instances, the gate time can be selected using the sum of the y interaction coordinate and the magnitude of the z interaction coordinate. In some embodiments, the following function can be defined:

$$ζ ( a ) = {max}_{b \geq a} \vert sin ( b ) / b \vert * a$$

This function is closely related to solutions to tan θ=θ. Denote θₖ the kth smallest positive solution to tan θ=θ. Then

$$ζ ( a ) = max \{ \vert sin ( a ) \vert , \frac{a}{\sqrt{{θ}_{k}^{2} + 1}} \} ,$$

where k is the smallest integer such that θₖ≥α. Given a set of candidate solutions {tₗ: |sin(tₗ)|=sin(x)} and the smallest l such that ζ(gt₁)≥sin (y+|z|), then tₗ will be the optimal driving time.

In some embodiments, the conventional computing device can determine dynamic decoupling gate drive amplitudes for the two qubits. The sum of the two gate drive amplitudes can depend on the sum of the y and z interaction coordinates. The difference of the two gate drive amplitudes can depend on the difference of the y and z interaction coordinates.

For example, in some embodiments, the two gate drive amplitudes can depend on two intermediate values ω₁, ω₂≥gtₗ. In such embodiments, the conventional computing device can find ω₁ such that |sin (ω₁)/ω₁|*gt₁=sin (y+z) and can find |sin (ω₂)/ω₂|*gtₗ=sin (y−z). The existence of these solutions is guaranteed by the continuity of |sin (ω)/ω|*gtₗ. In turn, the sum of the two gate drives can be selected as Ω₁+Ω₂=\sqrt{ω₁²−(gt₁)²}, while the difference of the two gate drives can be selected as Ω₁−Ω₂=\sqrt{ω₂²−(gt₁)²}.

In some embodiments, in addition to determining an implementation of the AshN gate locally equivalent to the identified two-qubit gate, the conventional computing device can determine one or more single-qubit gates. The single qubit gates can be corrections that cause the locally equivalent AshN gate to implement the original two-qubit gate.

In some instances, the AshN gate implementation may need to accommodate ZZ coupling between the qubits. In such instances, in terms of local equivalence, the characteristics | [symbol] 0|V₀|1 [symbol] | and | [symbol] 0|V₁|1 [symbol] | given above can be expressed as:

$$\vert 〈 0 \vert {V}_{0} \vert 1 〉 \vert = sin ( t * \sqrt{{( {Ω}_{1} + {Ω}_{2} )}^{2} + {( g + h )}^{2}} ) * \frac{g + h}{\sqrt{{( {Ω}_{1} + {Ω}_{2} )}^{2} + {( g + h )}^{2}}}$$

$$and$$

$$\vert 〈 0 \vert {V}_{1} \vert 1 〉 \vert = sin ( t * \sqrt{{( {Ω}_{1} - {Ω}_{2} )}^{2} + {( g - h )}^{2}} ) * \frac{g - h}{\sqrt{{( {Ω}_{1} - {Ω}_{2} )}^{2} + {( g - h )}^{2}}}$$

Appropriate values for the gate time and drive amplitudes can be obtained using these characteristics as described herein.

In step 430, the conventional computing device can provide commands to the quantum computing device (e.g., quantum component 320) to apply the gate sequence to the appropriate arrangement of qubits. The commands can specify parameters for the microwave drives (e.g., amplitude, phase, frequency, duration, or the like) to implement the AshN (or SWAP, or single-qubit) gates in the appropriate sequence. The quantum computing device can implement the quantum computational task by applying the gate sequence to the qubits.

In step 440, the conventional computing device can provide commands to the quantum computing device to readout the results of the quantum computational task. The disclosed embodiments are not limited to any particular method of reading out the results of the task.

The disclosed embodiments are not limited to embodiments including a quantum computing device. In some embodiments, application of the gate sequence to the appropriate arrangement of qubits can be simulated by the original conventional computing device or another, separate conventional computing device. For example, the gate sequence could be generated on a laptop and application of the gate sequence could be stimulated using a cloud-computing platform. Upon completion of the simulation, the simulation results could be provided to the original conventional computing device.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

The foregoing descriptions have been presented for purposes of illustration. They are not exhaustive and are not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps or inserting or deleting steps.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

The embodiments may further be described using the following clauses:
1. A system for performing a quantum computation comprising: a quantum component; and a classical component, the classical component including at least one processor, and at least one non-transitory computer-readable medium containing instructions that, when executed by the at least one processor, cause the classical component to perform operations comprising: obtaining a description of a quantum computational task; generating a gate sequence implementing the quantum computational task, the generation of the gate sequence comprising: identifying, in the gate sequence, a two-qubit gate to be applied to two qubits of the quantum component, the two-qubit gate associated with Weyl coordinates x, y, and z; determining a dynamic decoupling drive gate locally equivalent to the two-qubit gate, the determination of the dynamic decoupling drive gate comprising: determining a gate time for the dynamic decoupling drive gate; and determining a first amplitude of a first dynamic decoupling drive associated with a first one of the two qubits using: the gate time; a sum of the y and z coordinates; and a difference of the y and z coordinates; including the dynamic decoupling drive gate in the gate sequence at least partially in place of the two-qubit gate; and providing commands applying the gate sequence to the quantum component and obtaining an output from the quantum component.
2. The system of clause 1, wherein: the gate time is determined using: an interaction strength of the two qubits; and the x coordinate.
3. The system of clause 2, wherein: determining the gate time comprises: determining a minimum gate time such that a product of the interaction strength and the gate time is equivalent to the x coordinate under an equivalency condition.
4. The system of any one of clauses 1 to 3, wherein: determining the gate time comprises: determining a set of candidate gate times, the candidate gate times satisfying an x-coordinate equivalency condition; and selecting one of the set of the candidate gate times as the gate time.
5. The system of clause 4, wherein: the one of the set of the candidate gate times is selected using a sum of the y coordinate and a magnitude of the z coordinate.
6. The system of any one of clauses 1 to 5, wherein: the determination of the dynamic decoupling drive gate further comprises: determining a second amplitude of a second dynamic decoupling drive associated with a second one of the two qubits; wherein a sum of the first and second amplitudes depends on the sum of the y and z coordinates; and wherein a difference of the first and second amplitudes depends on the difference of the y and z coordinates.
7. The system of any one of clauses 1 to 6, wherein: the dynamic decoupling drive gate is determined in response to a determination that the two-qubit gate is not a swap gate.
8. The system of any one of clauses 1 to 7, wherein: one or more single qubit gates is included in the gate sequence together with the dynamic decoupling drive gate in place of the two-qubit gate.
9. A method for performing a quantum computation comprising: generating, by a classical computing system, a gate sequence implementing a quantum computational task, the generation of the gate sequence comprising: identifying, in the gate sequence, a two-qubit gate to be applied to two qubits of a quantum computing system, the two-qubit gate associated with Weyl coordinates x, y, and z; determining a dynamic decoupling drive gate locally equivalent to the two-qubit gate, the determination of the dynamic decoupling drive gate comprising: determining a gate time for the dynamic decoupling drive gate; and determining a first amplitude of a first dynamic decoupling drive associated with a first one of the two qubits using: the gate time; a sum of the y and z coordinates; and a difference of the y and z coordinates; including the dynamic decoupling drive gate in the gate sequence at least partially in place of the two-qubit gate; and providing commands applying the gate sequence to the quantum computing system and obtaining an output from the quantum computing system.
10. The method of clause 9, wherein: the gate time is determined using: an interaction strength of the two qubits; and the x coordinate.
11. The method of clause 10, wherein: determining the gate time comprises: determining a minimum gate time such that a product of the interaction strength and the gate time is equivalent to the x coordinate under an equivalency condition.
12. The method of any one of clauses 9 to 10, wherein: determining the gate time comprises: determining a set of candidate gate times, the candidate gate times satisfying an x-coordinate equivalency condition; and selecting one of the set of the candidate gate times as the gate time.
13. The method of clause 12, wherein: the one of the set of the candidate gate times is selected using a sum of the y coordinate and a magnitude of the z coordinate.
14. The method of any one of clauses 9 to 13, wherein: the determination of the dynamic decoupling drive gate further comprises: determining a second amplitude of a second dynamic decoupling drive associated with a second one of the two qubits; wherein a sum of the first and second amplitudes depends on the sum of the y and z coordinates; and wherein a difference of the first and second amplitudes depends on the difference of the y and z coordinates.
15. A non-transitory computer-readable medium containing instructions that, when executed by at least one processor of a classical computing system, cause the classical computing system to perform operations comprising: obtaining a description of a quantum computational task; generating a gate sequence implementing the quantum computational task, the generation of the gate sequence comprising: identifying, in the gate sequence, a two-qubit gate to be applied to two qubits of a quantum computing system, the two-qubit gate associated with Weyl coordinates x, y, and z; determining a dynamic decoupling drive gate locally equivalent to the two-qubit gate, the determination of the dynamic decoupling drive gate comprising: determining a gate time for the dynamic decoupling drive gate; and determining a first amplitude of a first dynamic decoupling drive associated with a first one of the two qubits using: the gate time; a sum of the y and z coordinates; and a difference of the y and z coordinates; including the dynamic decoupling drive gate in the gate sequence at least partially in place of the two-qubit gate; and providing commands applying the gate sequence to the quantum computing system and obtaining an output from the quantum computing system.
16. The non-transitory computer-readable medium of clause 15, wherein: the gate time is determined using: an interaction strength of the two qubits; and the x coordinate.
17. The non-transitory computer-readable medium of clause 16, wherein: determining the gate time comprises: determining a minimum gate time such that a product of the interaction strength and the gate time is equivalent to the x coordinate under an equivalency condition.
18. The non-transitory computer-readable medium of any one of clauses 15 to 17, wherein: determining the gate time comprises: determining a set of the candidate gate times, the candidate gate times satisfying an x-coordinate equivalency condition; and selecting one of the set of candidate gate times as the gate time.
19. The non-transitory computer-readable medium of clause 18, wherein: the one of the set of the candidate gate times is selected using a sum of the y coordinate and a magnitude of the z coordinate.
20. The non-transitory computer-readable medium of any one of clauses 15 to 19, wherein: the determination of the dynamic decoupling drive gate further comprises: determining a second amplitude of a second dynamic decoupling drive associated with a second one of the two qubits; wherein a sum of the first and second amplitudes depends on the sum of the y and z coordinates; and wherein a difference of the first and second amplitudes depends on the difference of the y and z coordinates.

In the drawings and specification, there have been disclosed exemplary embodiments. However, many variations and modifications can be made to these embodiments. Accordingly, although specific terms are employed, they are used in a generic and descriptive sense only and not for purposes of limitation or restriction of the scope of the embodiments, the scope being defined by the following claims.

What is claimed is:

1. A system for performing a quantum computation comprising:
a quantum component; and
a classical component, the classical component including at least one processor, and at least one non-transitory computer-readable medium containing instructions that, when executed by the at least one processor, cause the classical component to perform operations comprising:
obtaining a description of a quantum computational task;
generating a gate sequence implementing the quantum computational task, the generation of the gate sequence comprising:
identifying, in the gate sequence, a two-qubit gate to be applied to two qubits of the quantum component, the two-qubit gate associated with Weyl coordinates x, y, and z;
determining a dynamic decoupling drive gate locally equivalent to the two-qubit gate, the determination of the dynamic decoupling drive gate comprising:
determining a gate time for the dynamic decoupling drive gate; and
determining a first amplitude of a first dynamic decoupling drive associated with a first one of the two qubits using:
the gate time;
a sum of the y and z coordinates; and
a difference of the y and z coordinates;
including the dynamic decoupling drive gate in the gate sequence at least partially in place of the two-qubit gate; and
providing commands applying the gate sequence to the quantum component and obtaining an output from the quantum component.

2. The system of claim 1, wherein:
the gate time is determined using:
an interaction strength of the two qubits; and
the x coordinate.

3. The system of claim 2, wherein:
determining the gate time comprises:
determining a minimum gate time such that a product of the interaction strength and the gate time is equivalent to the x coordinate under an equivalency condition.

4. The system of claim 1, wherein:
determining the gate time comprises:
determining a set of candidate gate times, the candidate gate times satisfying an x-coordinate equivalency condition; and
selecting one of the set of the candidate gate times as the gate time.

5. The system of claim 4, wherein:
the one of the set of the candidate gate times is selected using a sum of the y coordinate and a magnitude of the z coordinate.

6. The system of claim 1, wherein:
the determination of the dynamic decoupling drive gate further comprises:
determining a second amplitude of a second dynamic decoupling drive associated with a second one of the two qubits;
wherein a sum of the first and second amplitudes depends on the sum of the y and z coordinates; and
wherein a difference of the first and second amplitudes depends on the difference of the y and z coordinates.

7. The system of claim 1, wherein:
the dynamic decoupling drive gate is determined in response to a determination that the two-qubit gate is not a swap gate.

8. The system of claim 1, wherein:
one or more single qubit gates is included in the gate sequence together with the dynamic decoupling drive gate in place of the two-qubit gate.

9. A method for performing a quantum computation comprising:
generating, by a classical computing system, a gate sequence implementing a quantum computational task, the generation of the gate sequence comprising:
identifying, in the gate sequence, a two-qubit gate to be applied to two qubits of a quantum computing system, the two-qubit gate associated with Weyl coordinates x, y, and z;
determining a dynamic decoupling drive gate locally equivalent to the two-qubit gate, the determination of the dynamic decoupling drive gate comprising:
determining a gate time for the dynamic decoupling drive gate; and
determining a first amplitude of a first dynamic decoupling drive associated with a first one of the two qubits using:
the gate time;
a sum of the y and z coordinates; and
a difference of the y and z coordinates;
including the dynamic decoupling drive gate in the gate sequence at least partially in place of the two-qubit gate; and
providing commands applying the gate sequence to the quantum computing system and obtaining an output from the quantum computing system.

10. The method of claim 9, wherein:
the gate time is determined using:
an interaction strength of the two qubits; and
the x coordinate.

11. The method of claim 10, wherein:
determining the gate time comprises:
determining a minimum gate time such that a product of the interaction strength and the gate time is equivalent to the x coordinate under an equivalency condition.

12. The method of claim 9, wherein:
determining the gate time comprises:
determining a set of candidate gate times, the candidate gate times satisfying an x-coordinate equivalency condition; and
selecting one of the set of the candidate gate times as the gate time.

13. The method of claim 12, wherein:
the one of the set of the candidate gate times is selected using a sum of the y coordinate and a magnitude of the z coordinate.

14. The method of claim 9, wherein:
the determination of the dynamic decoupling drive gate further comprises:
determining a second amplitude of a second dynamic decoupling drive associated with a second one of the two qubits;
wherein a sum of the first and second amplitudes depends on the sum of the y and z coordinates; and
wherein a difference of the first and second amplitudes depends on the difference of the y and z coordinates.

15. A non-transitory computer-readable medium containing instructions that, when executed by at least one processor of a classical computing system, cause the classical computing system to perform operations comprising:
obtaining a description of a quantum computational task;
generating a gate sequence implementing the quantum computational task, the generation of the gate sequence comprising:
identifying, in the gate sequence, a two-qubit gate to be applied to two qubits of a quantum computing system, the two-qubit gate associated with Weyl coordinates x, y, and z;
determining a dynamic decoupling drive gate locally equivalent to the two-qubit gate, the determination of the dynamic decoupling drive gate comprising:
determining a gate time for the dynamic decoupling drive gate; and
determining a first amplitude of a first dynamic decoupling drive associated with a first one of the two qubits using:
the gate time;
a sum of the y and z coordinates; and
a difference of the y and z coordinates;
including the dynamic decoupling drive gate in the gate sequence at least partially in place of the two-qubit gate; and
providing commands applying the gate sequence to the quantum computing system and obtaining an output from the quantum computing system.

16. The non-transitory computer-readable medium of claim 15, wherein:
the gate time is determined using:
an interaction strength of the two qubits; and
the x coordinate.

17. The non-transitory computer-readable medium of claim 16, wherein:
determining the gate time comprises:
determining a minimum gate time such that a product of the interaction strength and the gate time is equivalent to the x coordinate under an equivalency condition.

18. The non-transitory computer-readable medium of claim 15, wherein:
determining the gate time comprises:
determining a set of the candidate gate times, the candidate gate times satisfying an x-coordinate equivalency condition; and
selecting one of the set of candidate gate times as the gate time.

19. The non-transitory computer-readable medium of claim 18, wherein:
the one of the set of the candidate gate times is selected using a sum of the y coordinate and a magnitude of the z coordinate.

20. The non-transitory computer-readable medium of claim 15, wherein:
the determination of the dynamic decoupling drive gate further comprises:
determining a second amplitude of a second dynamic decoupling drive associated with a second one of the two qubits;
wherein a sum of the first and second amplitudes depends on the sum of the y and z coordinates; and
wherein a difference of the first and second amplitudes depends on the difference of the y and z coordinates.
